(19) United States
(12) Patent Application Publication
(10) Pub. No.: US 2011/0117893 A1
(43) Pub. Date: May 19, 2011

(54) Methods of Connecting A Phone User Telephonically By Text Keyword Using A Keyword Database

(75) Inventor: Isaac H. Sutton, New York, NY (US)

(73) Assignee: Go800, LLC, New York, NY (US)

(21) Appl. No.: 12/699,253

(22) Filed: Feb. 3, 2010

Related U.S. Application Data
(60) Provisional application No. 61/260,941, filed on Nov. 13, 2009.

(51) Int. Cl. H04M 3/42

(52) U.S. Cl. 455/414.1

(57) ABSTRACT

A method of connecting phone users telephonically by text message using text keywords and a keyword database is disclosed. Preferred methods of purchasing text keywords by website are also disclosed.

### REFERENCE TO RELATED APPLICATIONS

This application claims an invention which was disclosed in Provisional Application No. 61/260,941, filed Nov. 13, 2009, entitled “Methods of Connecting A Mobile Phone User Telephonically By Text Keyword Using A Keyword Database.” The benefit under 35 USC §119(e) of the United States provisional application is hereby claimed, and the aforementioned application is hereby incorporated herein by reference.

### BACKGROUND OF THE INVENTION

Mobile phones are now widely used in many countries including the United States. Some studies indicate that close to 90 percent of U.S. residents use a mobile phone.

Text messaging, or texting, allows the user of a mobile phone to send brief written messages. While the term most often refers to messages sent using the Short Message Service (SMS), it has been extended to include messages containing image, video, and sound content, such as MMS messages. Individual messages are referred to as “text messages” or “texts.”

The most common application of texting is person-to-person messaging, although text messages are also used to interact with automated systems, such as ordering products and services for mobile phones, or participating in contests. Advertisers and service providers use texts to notify mobile phone users about promotions, payment due dates, and other notifications that were previously sent by post or left as voicemail.

One common problem that phone users experience is the need to dial an unknown number. While some mobile phones offer advanced features like e-mail, Web browsing and other typical personal computing capabilities (sometimes called “smart phones,”) many phones do not have these capabilities. Moreover, finding contact information using the advanced features of a smart phone (which are not always available) is often time consuming and may be subject to additional fees.

In the past, if a phone user wanted to call an entity (such as a business or service provider) with unknown contact information, often the only reasonably practical manner of obtaining the number was to dial directory assistance with a standard number like “0” or “411”. Traditional directory assistance usually comprises a few automated attempts to determine the desired telephone number, which if unsuccessful connects the user to an operator for assistance. A mobile phone user (who may be driving or otherwise distracted) then has to remember the contact number, although some directory assistance services will send you the contact number by text, sometimes requiring an additional fee. Traditional directory assistance services are often time-consuming and expensive.

Moreover, in general it is difficult to remember the multiple digit numbers required for typical phone connection. People tend to remember names, brands and words in general much better than numbers.

Therefore, the need exists for a fast, inexpensive, easy-to-use method to contact entities without preexisting knowledge of the phone number. Moreover, leveraging modern communications to allow consumers to remember words, such as brand names, rather than numbers would be advantageous. The applicant has invented a method that, in the preferred embodiment, leverages the text sending capabilities of mobile phones combined with a keyword database to perform improved connection services without many of the disadvantages of traditional directory assistance.

### FIELD OF THE INVENTION

The invention pertains to the field of mobile phone communications. More particularly, the invention pertains to a method of forming telephone connections between a phone user and an entity with unknown contact information. The phone user sends a text keyword, which is then used to form a phone connection by utilizing a keyword database.

### DESCRIPTION OF RELATED ART

U.S. Pat. No. 6,694,007, the disclosure of which is hereby incorporated by reference, describes parsing a text message to connect a toll call. However, there is no disclosure of a database that relates particular text to one or more particular numbers, such that connections to entities with unknown contact information are facilitated through a keyword database.

U.S. Pat. No. 5,966,652, the disclosure of which is hereby incorporated by reference, also describes a method of using text messages to create a phone connection. However, there is no disclosure of a keyword database that relates particular keyword text to a one or more phone numbers to facilitate telephonic connection.

### SUMMARY OF THE INVENTION

The invention utilizes a keyword database that correlates a text keyword to one or more phone numbers. For example, the database might correlate a brand name with one or more phone numbers for the relevant company that owns the brand.

Thus, a phone user can send a text keyword that results in a relevant phone connection based on a keyword database. Moreover, methods for text keyword purchase by website are described.

### BRIEF DESCRIPTION OF THE DRAWINGS

FIG. 1 shows a flow chart for the preferred embodiment of obtaining the phone user information and text keyword for use in the invention;

FIG. 2 shows a flow chart for the preferred method of using the phone user information, the text keyword and the keyword database to create a phone connection between a phone user and a desired connection; and

FIG. 3 shows a flow chart for the preferred embodiment of allowing customers to purchase text keywords by website.

### DEFINITIONS

For purposes of this application, the following definitions apply to various terms:

“Text keyword” is text that corresponds to one or more phone numbers related to the text.

For example, the text keyword might be a brand name which corresponds to one or more phone numbers that connect to relevant numbers at the company that owns the brand. The text keyword could also be a generic descriptor for goods or services, or may correspond to a proper name, so long as it correlates with one or more relevant phone numbers.

“Keyword database” means an electronic database in any format or structure that correlates the text keywords with one or more relevant phone numbers.

### DETAILED DESCRIPTION OF THE INVENTION

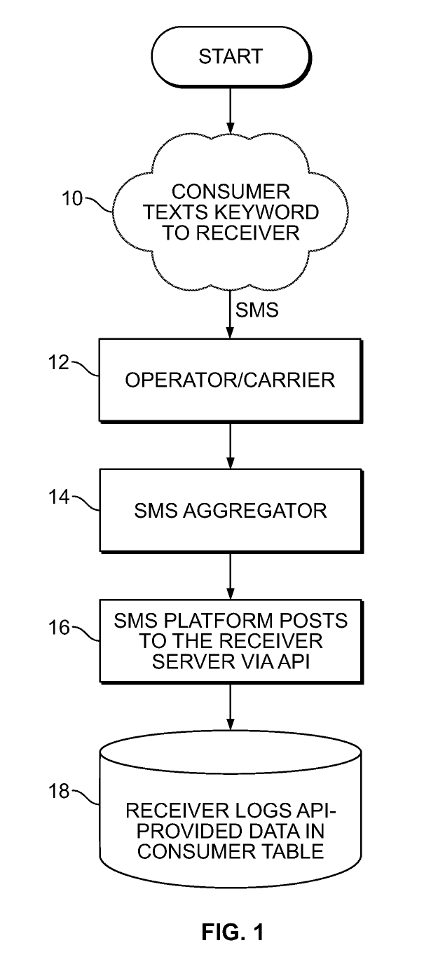

As shown in FIG. 1, the phone user (labeled “consumer”) sends a text keyword to a receiver (10). The receiver can be any electronic instrument capable of receiving a text keyword. In the preferred embodiment, the receiver is a typical 5 digit commercial text message receiver. In the preferred embodiment, the text keyword is sent by Short Message Service (SMS), although the text could be sent by a variety of communication protocols, including MMS and email.

In one embodiment, the text keyword corresponds to the brand name of the company the mobile phone user wishes to reach. In an alternative embodiment, the keyword corresponds to a generic descriptor of goods and services (such as “pizza” or “bank”).

Thus, in the preferred embodiment, in order to reach a desired company, the mobile phone user does not need to remember the phone number for the company. Instead, in the preferred embodiment, the mobile phone user sends a keyword text message (the keyword being, for example, the company name or brand) to the receiver. In the preferred embodiment, the phone user does not need know anything other than the company brand name the user wishes to reach and the text message receiver number in order to be connected telephonically. For the vast majority of phone users, this is far easier than trying to remember the minimum of seven digits that correspond to a particular company's phone number.

As shown in FIG. 1, in the preferred embodiment the operator/carrier (12) sends the text keyword by conventional SMS text transmission means to the SMS aggregator (14). In the preferred embodiment, SMS aggregator (14) then sends the SMS data to the SMS platform at the receiver using a known API (16). In the preferred embodiment, the receiver then logs the data provided by the API into a consumer table (18). While FIG. 1 shows the preferred embodiment, one of skill in the art would appreciate that there would be a variety of methods to implement the invention, and that the transmission, format and structure of the data may be implemented in a variety of ways. Different text protocols (such as email) would use different steps, but would all result in a text keyword received from a phone.

As mentioned above, the structure and form of the data are not important, but must contain two critical pieces of information about the phone user—the user's phone number and the keyword text that indicates the desired telephonic connection. SMS text messages contain the phone user's number and can easily transmit keyword text. In alternative embodiments that do not use SMS text, some data relating the text message to the user's phone number must be obtained, either by phone user registration or other alternatives known to those in the art.

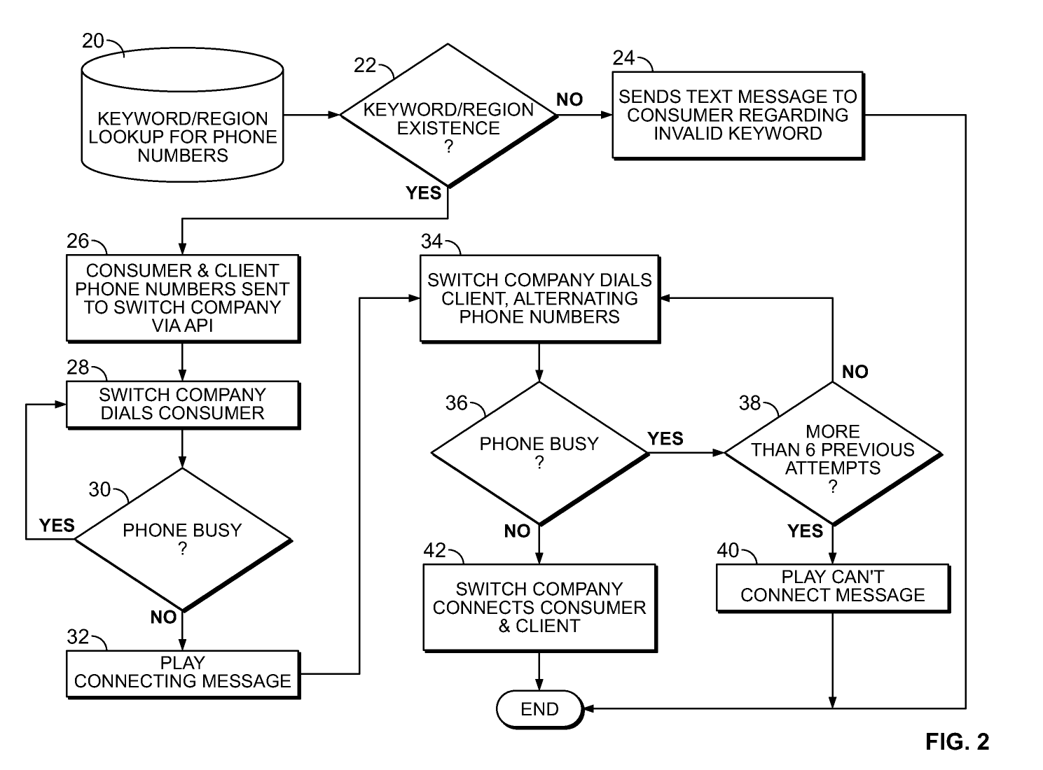

As shown in FIG. 2, the text keyword is applied to a keyword database which correlates keywords with phone numbers (20). In the preferred embodiment, the database is regionally segregated by the area code of the mobile phone user (or other information about the mobile phone user which may be available, such as GPS data or through further communication with the mobile phone user by text—such as requesting zip code or other information), although such geographic segregation is not required to practice the invention. One of skill in the art might have the system of the invention send a variety of messages to the mobile phone user in order to determine the particular phone number the mobile phone user desired to reach. In the preferred embodiment, the text keyword may correspond to different numbers depending on the location of the location of the mobile phone user or other data about the mobile phone user, although such alternatives are not required to practice the invention.

As further shown in FIG. 2, in the preferred embodiment the text keyword is checked to make sure that a corresponding phone number exists for that text keyword (22). In the preferred embodiment, if no phone number exists that corresponds to the text sent by the mobile phone user, a message conveying such is sent to the mobile phone user (24).

As further shown in FIG. 2, assuming that a phone number corresponding to the text keyword exists, the phone number of the mobile phone user sending the text keyword and the phone number that corresponds to the text keyword are sent to a phone switch (26). The phone switch may connect the two numbers—the user's mobile phone number sending the text keyword and the corresponding number from the keyword database—in any number of different methods known to those of skill in the art. The switch may be any component that allows for the connection between two phone numbers and may be a softswitch and/or utilize other components such as a feature server or media gateway controller.

In the preferred embodiment, the phone switch company dials the mobile phone user first (28). In the preferred embodiment, if the mobile phone user's line is busy, the switch company continues to try and contact mobile phone user until mobile phone user accepts the incoming call (30).

As shown in the preferred embodiment of FIG. 2, once the mobile phone user that sent the keyword text accepts the incoming call, a message indicating that they are to be connected with their desired party is sent from the switch company (32). This message may contain information about the connection services company providing the connection and/or indications that the consumer is going to be connected with one of the numbers associated with the text keyword in the keyword database, although such a message is not required to practice the invention.

As shown in the preferred embodiment of FIG. 2, the switch then attempts to connect the mobile phone user with the desired company based on phone number that corresponds to the text keyword in the keyword database (34). In the preferred embodiment, after numerous unsuccessful attempts (36), the switch carrier will abort the connection (38). In the preferred embodiment, under these circumstances, the switch carrier indicates to the mobile phone user that the call cannot be completed (40).

As shown in the preferred embodiment of FIG. 2, the mobile phone user and the company corresponding to the keyword are connected by the switch. In the preferred embodiment, the connection is at little to no expense to the mobile phone user, and will typically be far less expensive and time consuming than traditional phone directory assistance. Moreover, assuming the keyword database is accurately and expansively populated, a mobile phone user need only remember the company name or brand and the text receiver number (which might be programmed automatically into the mobile phone) in order to make a phone connection.

Other embodiments of the invention are also possible. For example, the text keyword could be particular names or contacts at a given company. The receiver number could correspond to the company name. Thus, in order to be connected to a given contact at a company, the mobile phone user could text the person's name to a receiver that corresponded to the company. Other similar embodiments of the invention would be apparent to one of skill in the art.

Other embodiments of the keyword database are also within the scope of the invention. The keyword database may be configured to connect different phone numbers in response to different input from the mobile phone user, as described above. Another embodiment would allow manipulation of the connection numbers so that different numbers are used based on time of day, the recipients travel plans, etc. Traditional phone number functions such as forwarding, call waiting, caller id, etc., while not necessary to practice the invention, are all possibilities.

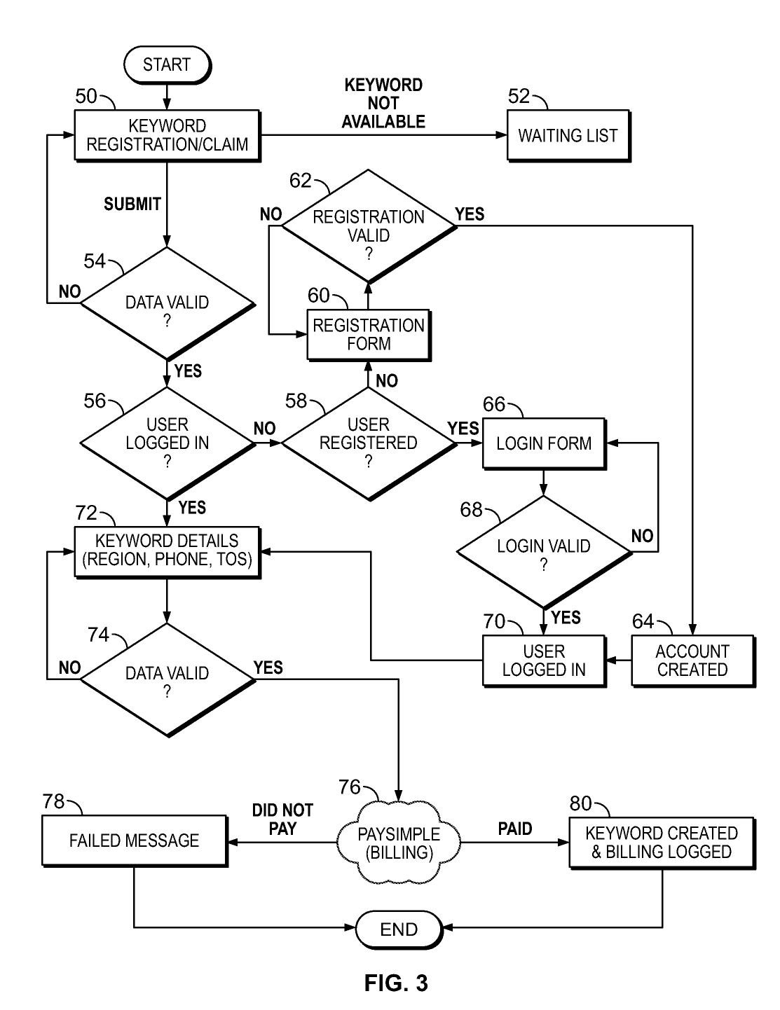

As shown in the preferred embodiment of FIG. 3, the invention also allows for a website-enabled registration process for text keywords, as well as entering corresponding numbers. In the preferred embodiment, the text keyword purchaser is first asked which text keyword is desired for purchase (50). In the preferred embodiment of FIG. 3, if the keyword has already been purchased, the purchaser is put on a waiting list in case the keyword becomes available (52). Another embodiment allows the website to generate automatic notices to companies when previously unavailable keywords become available for purchase.

In the preferred embodiment of FIG. 3, companies are only allowed to purchase text keywords that correspond to their own brand names and generic keywords that correspond to goods or services of the company. Various authentication and dispute resolution processes known in the art can be utilized for keyword purchase. This is shown as the data validation step (54) in the preferred embodiment shown in FIG. 3. Moreover, the keyword is also checked to determine whether the form is permissible given the data structures and any other requirements of the text keyword receiver in the preferred embodiment.

As shown in the preferred embodiment of FIG. 3, the website uses a typical log in and registration process for those wishing to purchase keywords which are well known in the art. In the preferred embodiment, first the website determines if the user is logged in (56) using, for example, a username and password given as part of a typical registration process. If the purchaser has not logged in, the website determines if the purchaser is registered (58). If the purchaser is not registered, the website provides a typical registration form (60) and checks whether or not the registration form data is valid (62). Once valid data is entered into the registration form, then an account is created (64). Once the purchaser has a valid registration, the purchaser can log into the website (66) using typical means known in the art such as a username and password. Assuming the log in data is entered correctly (68) the purchaser is logged in (70). If the purchaser has previously registered, the purchaser can directly log into the website (56).

As shown in the preferred embodiment of FIG. 3, once the registered purchaser is logged in, various data related to the keyword purchase is acquired, including at least the phone number(s) that will correspond to the text keyword in the database (68). As previously described, a text keyword may correspond to different numbers, based on a variety of data, such as the geographic location of the mobile phone user, which may be determined by the area code of the mobile phone number, GPS or other electronic location data, or in response to text message inquiries. Other information, such as the terms of service, license, etc. may also be included in the preferred embodiment.

In the preferred embodiment of FIG. 3, the various data entered by the purchaser are checked for validity (74) and then billing for the text keyword is set up (76). Assuming no billing failure, which results in a message indicating such (78), then in the preferred embodiment the website creates the keyword for use in the keyword database in response to a keyword text (80). In the preferred embodiment, billing for the keyword is also logged (80).

Although not shown, the manipulation of the phone numbers in response receipt of a text keyword could also be manipulated by website by the text keyword purchaser. Also not shown is the ability of the text keyword purchaser to enter different numbers in response to different data, such as location, time of day, etc., although such embodiments would be apparent to one of skill in the art.

Accordingly, it is to be understood that the embodiments of the invention herein described are merely illustrative of the application of the principles of the invention.

What is claimed is:

1. A method of connecting a phone user telephonically using text comprising:
a. sending a text keyword to a receiver;
b. determining at least one phone number corresponding to the text keyword from a keyword database;
c. attempting to connect the phone user telephonically to at least one of the phone numbers that correspond to said text keyword in the keyword database.

2. The method of claim 1, further comprising connecting the phone user telephonically to a phone number corresponding to said text keyword.

3. The method of claim 1, wherein a failure to connect the phone user to at least one of said phone numbers generates a message to the phone user.

4. The method of claim 2, wherein the text keyword corresponds to a brand or company name.

5. The method of claim 2, wherein the text keyword corresponds to a proper name.

6. The method of claim 1, wherein the text keyword is sent by SMS.

7. The method of claim 6, wherein a switch is used to connect the phone user with at least one telephone number corresponding to the text keyword in the keyword database.

8. The method of claim 7, wherein the switch includes one or more of the group consisting of a softswitch, feature server or media gateway controller.

9. The method of claim 6, wherein the phone number corresponding to the text keyword is determined at least in part by geographic information about the phone user.

10. The method of claim 1, wherein a website can be used to purchase the use of text keywords.

11. The method of claim 1, wherein a website can be used to change one or more phone numbers that correspond to a text keyword in a keyword database.

12. A method of connecting a mobile phone user telephonically using text comprising:
a. sending an text keyword by SMS message to an SMS receiver;
b. determining at least one phone number corresponding to the text keyword from a keyword database;
c. connecting the mobile phone user telephonically to at least one of the phone numbers that correspond to the text keyword in the keyword database using a switch.

13. The method of claim 12, wherein the switch includes one or more of the group consisting of a softswitch, feature server or media gateway controller.

14. The method of claim 12, wherein the text keyword corresponds to a brand or company name.

15. The method of claim 12, wherein the text keyword corresponds to a proper name.

16. The method of claim 12, wherein a website can be used to purchase the use of keywords.

17. The method of claim 16, wherein a website can be used to change one or more phone numbers that correspond to a text keyword in a keyword database.

18. The method of claim 17, wherein the phone number that corresponds to a keyword in a keyword database is determined at least in part by geographic information about the mobile phone.

19. The method of claim 17, wherein determining the phone number that corresponds to the text keyword in the keyword database uses the area code of the mobile phone user from the text keyword sent by SMS.

20. A method of connecting a mobile phone user to a desired phone number using text comprising:
a. sending an SMS text keyword to a receiver;
b. deriving the user's mobile phone number from the SMS text;
c. deriving a phone number from the SMS text keyword using a keyword database;
c. attempting to connect the mobile phone number derived from the SMS text and the phone number derived from the text keyword using a keyword database.

21. The method of claim 20, wherein a switch is used to attempt to connect the derived mobile phone number with the phone number derived from the SMS text keyword using a keyword database.

22. The method of claim 21, wherein the switch includes one or more of the group consisting of a softswitch, feature server or media gateway controller.

23. The method of claim 21, wherein the switch first attempts to connect with the derived mobile phone number.

24. The method of claim 23, wherein a message is sent to the mobile phone number if the attempt by the switch to connect is unsuccessful.

25. The method of claim 23, wherein the switch attempts to connect with the phone number derived from the SMS text keyword only after the attempt to connect with the mobile phone user is successful.

26. The method of claim 23, wherein the SMS text keyword corresponds to a brand or company name.

27. The method of claim 23, wherein the SMS text keyword corresponds to a proper name.

28. The method of claim 25, wherein the phone number derived from the keyword database from the SMS text keyword is derived in part by geographic information about the mobile phone user.

29. The method of claim 25, wherein determining the phone number that corresponds to the text keyword in the keyword database uses the area code of the mobile phone user from the SMS text keyword.

30. The method of claim 25, wherein a website can be used to purchase the use of text keywords.

31. The method of claim 30, wherein a website can be used to change one or more phone numbers that correspond to a text keyword in a keyword database.
